(19) United States
(12) Patent Application Publication
(10) Pub. No.: US 2015/0006898 A1
(43) Pub. Date: Jan. 1, 2015

(54) Method For Provisioning Security Credentials In User Equipment For Restrictive Binding

(71) Applicant: Alcatel-Lucent USA Inc., Murray Hill, NJ (US)

(72) Inventor: Semyon B. Mizikovsky, Morganville, NJ (US)

(73) Assignee: Alcatel-Lucent USA Inc., Murray Hill, NJ (US)

(21) Appl. No.: 13/930,872

(22) Filed: Jun. 28, 2013

(51) Int. Cl. H04L 29/06

(52) U.S. Cl. CPC H04L 63/0428
USPC 713/176

(57) ABSTRACT

A binding verification scheme based on a proof of possession of the device-specific secret key associated with the reported IMEI is provided. The IMEI reported by user equipment (UE) is checked to make sure that it matches the IMEI configured into the UE by the manufacturer and has therefore not been modified by an attacker.

### FIELD OF THE INVENTION

The present invention relates generally to communication systems.

### BACKGROUND OF THE INVENTION

For some Machine-to-Machine (M2M) device configurations, it may be necessary to restrict the access of a UICC (Universal Integrated Circuit Card) that is dedicated to be used only with machine type modules associated with a specific billing plan. It should be possible to associate a list of UICC to a list of terminal identity such as IMEI/SV (International Mobile Equipment Identity/Software Version) so that if the UICC is used in another terminal, the access will be refused.

One of the solutions for addressing this requirement for IMSI-IMEI pairing leverages a symmetric common secret, K_{ME}, between the mobile device, called here User Equipment (UE), and the 3GPP network, specifically, the Home Subscriber Server (HSS).

The identity of each UE, the IMEI, as configured during manufacturing, can be manipulated by an attacker, and as a result the UE will identify itself with a different IMEI.

There are no currently defined efficient provisioning schemes for security credentials for binding subscriptions to M2M terminals.

In the case where the IMEI is hacked, even though the UE subscription identified as IMSI (International Mobile Subscriber Identity) and its associated subscription credentials stored on the UICC are authenticated, the IMEI reported by the UE is not validated by currently defined 3GPP protocols, and is not included in the authentication process. So a hacked UE is able to utilize services for which it was not entitled or is not currently subscribed to.

Therefore, a need exists for a method of ensuring that the IMEI programmed in a piece of user equipment and reported by this piece of equipment to the network has not been manipulated. This will ensure that each subscription is restricted to operate only with the authorized UE.

### BRIEF SUMMARY OF THE INVENTION

An exemplary embodiment solves the above stated problems of restricting the IMSI to a specific authorized and verifiable IMEI. An exemplary embodiment allows deployment of the binding verification scheme based on a proof of possession of the device-specific secret key associated with the reported IMEI. Therefore the IMEI reported by the UE is checked to make sure that it matches the IMEI configured into the UE by the manufacturer and has therefore not been modified by an attacker.

Exemplary embodiments of the present invention provide a method of secure provisioning of the secret UE-specific credential, K_{ME}, in the UE and the HSS with assurance of the UE identity (IMEI).

According to one exemplary embodiment, the symmetric security key that needs to be provisioned is generated by the UE, digitally signed using the device-specific Private Key, and along with the signature is encrypted using the Manufacturer-specific Public key.

When delivered to the HSS, the encrypted package is decrypted by using a Manufacturer-specific Private key. The digital signature is verified using the Device-specific Public key, and the decrypted device-specific symmetric secret is provisioned into the HSS subscription database.

To attest to the proper reception and decryption of this key, the HSS preferably returns the key signature to the UE, and upon its validation, the UE provisions the key into its secure environment. The provisioned key can then be used to ensure the proper binding of the subscription to the UE. An exemplary embodiment describes the method of secure provisioning of the K_{ME} in the UE and the HSS with assurance of the UE identity (IMEI).

### BRIEF DESCRIPTION OF THE SEVERAL VIEWS OF THE DRAWINGS

FIG. 1 depicts the functional architectural of a communication network in accordance with an exemplary embodiment of the present invention.

FIG. 2 depicts a call flow diagram in accordance with an exemplary embodiment of the present invention.

### DETAILED DESCRIPTION OF THE INVENTION

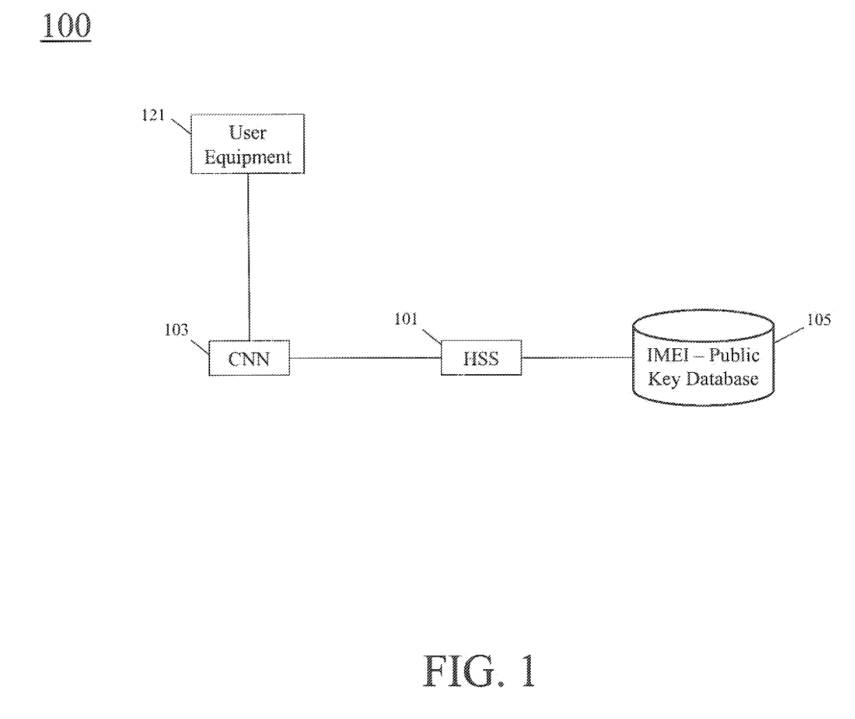

FIG. 1 depicts the functional architectural of communication network 100 in accordance with an exemplary embodiment of the present invention. Communication network 100 includes Home Subscriber Server (HSS) 101, Control Network Node (CNN) 103, IMEI—Public Key Database 105, and User Equipment (UE) 121.

HSS 101 is a master user database that supports the network entities that actually handle calls. HSS 101 includes the subscription-related information, such as subscriber profiles, performs authentication and authorization of the user, and can provide information about the subscriber's location and IP information.

CNN 103 is the primary service control node and is responsible for controlling the mobile sessions and services. CNN 103 preferably sets up and releases the end-to-end connection, handles mobility and hand-over requirements during the call or data session, and takes care of charging and real time pre-paid account monitoring. CNN 103 may comprise an MME (Mobility Management Entity), which is the key control-node for an LTE access-network. CNN 103 may also comprise an SGSN (Serving GPRS support node), which is responsible for the delivery of data packets from and to the mobile stations within its geographical service area.

IMEI—Public Key Database 105 is a centrally located database of valid and stolen handset IMEIs to which the operator of communication network 100 may connect to upload and download data to control mobile device access on communication network 100.

UE 121 is a wireless device that is capable of communication to and from communication network 100. Examples include cellular phones, Personal Digital Assistants (PDAs), and other wireless devices.

When configuring the IMEI in UE 121 during manufacturing, the manufacturer generates for UE 121 a pair of Private and Public Keys that are uniquely associated with the IMEI of UE 121. The Private Key is stored in the secure area of UE 121, while the Public Key is deposited into a common database accessible to Network Operators, such as IMEI—Public Key Database 105, or their provisioning systems.

In addition, UE 121 is preferably provisioned with the manufacturer-specific Modulus N which represents the product of two large prime numbers P and Q (N=P*Q). Requirements for selection of prime factors P and Q are preferably as defined in ANSI X9.31 for RSA algorithm. The Primes P and Q are secret, and known to HSS 101 as associated with each specific manufacturer. A manufacturer may choose to vary the P, Q, and N on a per-manufacturing lot basis, or other criteria. In knowing the IMEI, HSS 101 should be able to obtain required P and Q for each UE.

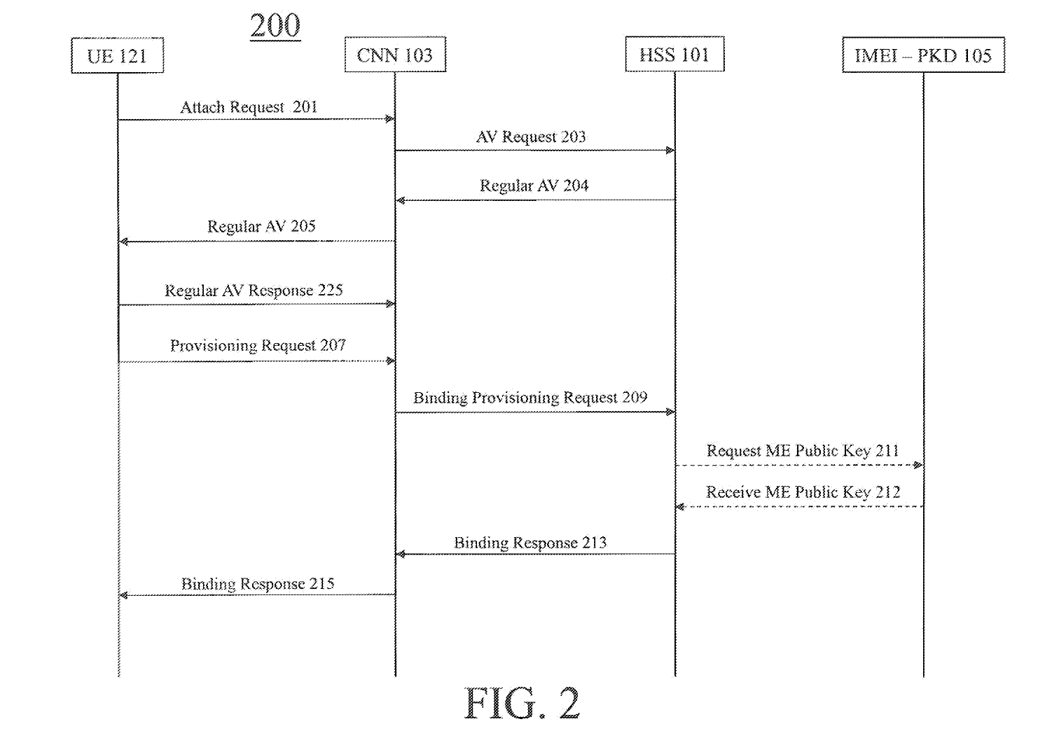

FIG. 2 depicts a call flow diagram 200 in accordance with an exemplary embodiment of the present invention.

When a newly subscribed UE, such as UE 121 in this exemplary embodiment, accesses communication network 100, HSS 101 determines if the newly subscribed UE has binding information for the subscription. If not, HSS 101 preferably invokes the provisioning procedure to establish the K_{ME} in UE 121. In an alternate exemplary embodiment, if HSS 101 needs to find out the IMEI of UE 121 by the subscription (IMSI), HSS 101 invokes the provisioning procedure to establish the K_{ME} in UE 121. This preferably happens in the following manner.

UE 121 sends Attach Request 201 to CNN 103. Attach Request 201 includes the IMSI of UE 121 and is a request to access the network for service. In this exemplary embodiment, a UICC with IMSI is installed in UE 121 and the K_{ME} is either not provisioned or is unknown to CNN 103.

CNN 103 sends AV Request 203 to HSS 101. AV Request 203 includes the IMSI of UE 121 and requests the Authentication Vector to authenticate the IMSI of UE 121.

HSS 101 determines that the IMSI from AV Request 203 needs to be bound to the device, UE 121. In this exemplary embodiment, the Binding Credential (K_{ME}) is not yet established for UE 121. In addition, HSS 101 needs to obtain the IMEI of the UE currently used by the subscription. In order to conduct the provisioning procedure, HSS 101 allows authenticated access without using the device binding, because the binding association has not yet been established.

HSS 101 issues an Authentication Vector by sending Regular AV 204 to CNN 103. In an exemplary embodiment, HSS 101 indicates to CNN 103 that the access is authorized only and exclusively for the special purpose of provisioning binding credentials. Consequently any bearer establishment is disallowed. In addition, HSS 101 also indicates to CNN 103 that the provisioning of the K_{ME} has to take place, as well as the IMEI of UE 121 must be reported. In accordance with an exemplary embodiment, the air interface and NAS security are invoked at this point, so all subsequent interactions with UE 121 are protected.

CNN 103 sends Regular AV 205 to UE 121. In an exemplary embodiment, this initiates the AKA Authentication procedure.

UE 121 receives Regular AV 205 and recognizes it as an Authentication Challenge. In an exemplary embodiment, UE 121 recognizes that the received Authentication Challenge is unprocessed, and forwards it to the UICC within UE 121. In this embodiment, the AKA Authentication is concluded with unprocessed AV. As one example, in PS GERAN and PS UTRAN the SGSN/MSC can also request and receive the IMEI of UE 121 in this transaction.

UE 121 sends Regular AV Response 225 to CNN 103. UE 121 generates a random K_{ME}, typically 128-bit in size, in accordance with known procedures. UE 121 preferably generates a random nonce R_{ME}, typically 128-bit in size. UE 121 computes a digital signature K_{ME}_{_{—}}SIG using device-specific Private Key and a generated random nonce R_{ME}. UE 121 then preferably concatenates (K_{ME}|K_{ME}_{_{—}}SIG|R_{ME}) and encrypts it using the RSA algorithm as specified in ANSI-X9.31. In accordance with an exemplary embodiment, the following formula is used:

{K_{ME}|K_{ME}_{_{—}}SIG|R_{ME}}′={K_{ME}|K_{ME}_{_{—}}SIG|R_{ME}}̂e mod N,

where e is a predetermined Public Exponent, e.g. 2¹⁶+1 as recommended by FIPS-186-3, and N is specific for the device manufacturer.

In addition, UE 121 pre-computes the expected signature of the network, the xNW_SIG, as a hash of K_{ME} and R_{ME}, preferably using the equation:

xNW_SIG=SHA256(K_{ME}|R_{ME})

In accordance with an exemplary embodiment, by using the provisioned Private Key, UE 121 generates the Digital Signature of the K_{ME}, the K_{ME}_{_{—}}SIG, using the Elliptic Curve Digital Signature Algorithm (ECDSA) as specified in FIPS-186-3. In a second exemplary embodiment, UE 121 computes a regular DSA signature as specified in FIPS-186-3. UE 121 then encrypts the (K_{ME}|K_{ME}_{_{—}}SIG|R_{ME}), preferably using RSA encryption with manufacturer-specific Modulus N.

UE 121 sends Provisioning Request 207 to CNN 103. Provisioning Request 207 is preferably an NAS message. Provisioning Request 207 preferably includes the IMSI, IMEI, and encrypted (K_{ME}|K_{ME}_{_{—}}SIG|R_{ME}).

CNN 103 sends Binding Provisioning Request 209 to HSS 101. This preferably initiates the S6a transaction defined for establishment of binding credentials. Binding Provisioning Request 209 preferably includes the IMSI, IMEI, and encrypted (K_{ME}|K_{ME}_{_{—}}SIG|R_{ME}).

HSS 101 sends Request UE Public Key 211 to IMEI—Public Key Database 105. Request UE Public Key 211 includes the IMEI associated with UE 121.

IMEI—Public Key Database 105 retrieves the Public Key associated with the received IMEI according to known protocols. IMEI—Public Key Database 105 returns Receive ME Public Key 212 to HSS 101. Receive ME Public Key 212 includes the Public Key associated with the IMEI of UE 121.

HSS 101 receives Receive ME Public Key 212. HSS 101 obtains the P & Q factors of N associated with the device manufacturer of UE 121, and decrypts the (K_{ME}|K_{ME}_{_{—}}SIG|R_{ME}) payload received in Receive ME Public Key 212. Using received factors, HSS 101 decrypts the encrypted (K_{ME}|K_{ME}_{_{—}}SIG|R_{ME}) payload. HSS 101 preferably validates the K_{ME}_{_{—}}SIG using the ME Public Key that was received in Receive ME Public Key 212. If the validation succeeds, HSS 101 stores the K_{ME} in the subscription record database in association with the bound IMEI of UE 121. To prove to UE 121 that HSS 101 properly decrypted the K_{ME}, HSS 101 preferably generates its own hash of the K_{ME}, the NW_SIG, using decrypted R_{ME} as a freshness parameter, utilizing the following formula.

NW_SIG=SHA256(K_{ME}|R_{ME})

HSS 101 sends Binding Response 213 to CNN 103. Binding Response 213 preferably includes the NW_SIG.

CNN 103 sends Binding Response 215 to UE 121. Binding Response 215 includes the NW_SIG.

UE 121 validates the received NW_SIG. The computed NW_SIG is returned to UE 121 which compares it to the pre-computed xNW_SIG. If this validation succeeds, UE 121 activates the K_{ME} in its secure memory for binding compliance. In addition, UE 121 preferably populates the K_{ME} into the HSS subscription database and can now be used for pre-processing authentication vectors. In accordance with an exemplary embodiment, HSS 101 will expect UE 121 to use the binding feature during the next network access and will generate a pre-processed AV.

An exemplary embodiment thereby provides a secure solution that provides multiple improvements over the prior art. Only the HSS that has possession of secret Prime Factors P and Q can correctly decrypt the keying material sent by a UE. A legitimate HSS preferably has access to these values.

Further, only the UE that is provisioned with the Private Key associated with the reported IMEI can correctly generate the Digital Signature of the randomly created key K_{ME}. The HSS preferably has access to the Public Key associated with the reported IMEI. When the Digital Signature is properly validated, the HSS is certain that the Digital Signature has been generated by the device with the reported IMEI.

Additionally, when the correct secure hash of the K_{ME}, in this exemplary embodiment the NW_SIG, is returned by the HSS, the UE gets assured that the HSS correctly decrypted the K_{ME} and so binding can be safely invoked.

Commonly defined security suites that combine encryption and digital signatures, such as those defined in IETF RFC 5289, RFC 6637, etc., typically use the same pair of Public and Private keys to first run a public key algorithm to generate the set of symmetric keys. They then typically use these symmetric keys for encryption of a payload. In addition these suites use the same pair of Public and Private keys to generate the digital signature of the package. The same set of Public and Private keys is used by the receiving peer to validate the signature, and then decrypt the package.

In contrast to these common security suites, an exemplary embodiment of the present invention uses two different sets of Public/Private key pairs for two different purposes, which effectively are combined in getting a desired result. One Device-specific Private Key is used to digitally sign the created random secret to be established, the K_{ME}. This signature is verified by the network that has a legitimate access to the corresponding device-specific Public Key.

In accordance with an exemplary embodiment, another manufacturer-specific Public Key is used to encrypt the package that contains the K_{ME} and its digital signature. This package can be decrypted by the network that has legitimate access to the manufacturer-specific Private Keys. In combination, these two unrelated phases of key establishment result in provisioning of the secret symmetric K_{ME} in the ME and the HSS.

In an alternate exemplary embodiment, HSS 101 is pre-provisioned with a list of allowable IMSI/IMEI pairs and has access to the public key associated with each IMEI. UE 121 performs the attach procedure as depicted in FIG. 2. CNN 103 and UE 121 complete an authentication and establishment of security. The core network node also requests and receives the IMEI from UE 121.

HSS 101 realizes that the IMSI/IMEI Binding is required, but in this alternate exemplary embodiment K_{ME} is not yet provisioned. HSS 101 indicates to CNN 103 that Provisioning of the K_{ME} is expected.

CNN 103 requests an encrypted K_{ME} from HSS 101 by sending HSS 101 the IMEI. HSS 101 generates a new K_{ME} and encrypts the new K_{ME} with the public key (PubK) of the received IMEI in anticipation that it can only be decrypted by the UE that possesses the associated Private Key.

HSS 101 also encrypts the K_{ME} with the local block encryptor to produce a Cookie. The encryption key for producing the Cookie is preferably kept in HSS 101 and not shared with any entity. The encryption key is preferably only needed for decrypting the Cookie again when received back from CNN 103.

HSS 101 generates the random Nonce, and hashes it with K_{ME} producing expected response XRsp.

In this alternate exemplary embodiment, HSS 101 sends the encrypted (K_{ME}, Nonce)_{PubK}, Cookie, and XRsp to CNN 103. CNN 103 forwards the (K_{ME}, Nonce)_{PubK} UE 121.

UE 121 preferably decrypts the K_{ME} using its Private Key (PrK). UE 121 hashes the K_{ME} and Nonce to produce the Rsp. UE 121 also uses the Private Key (PrK) to generate the digital signature (DSA) of K_{ME}.

UE 121 returns the Rsp and DSA (K_{ME}) to CNN 103. CNN 103 compares the Rsp with XRsp, and if they match, CNN 103 sends a Location Update Request to HSS 101. The Location Update Request preferably include the IMSI, IMEI, the Cookie, and the DSA (K_{ME}).

In this exemplary embodiment, HSS 101 uses its internal secret to decrypt the Cookie and obtain the K_{ME}. HSS 101 then uses the Public Key associated with the IMEI to verify the DSA of K_{ME}. If verification is successful. HSS 101 gets assured that the Cookie was not substituted by an unscrupulous CNN and the K_{ME} was properly decrypted and accepted by a legitimate UE. HSS 101 stores the K_{ME} in association with the IMEI if the IMSI/IMEI pair is allowed.

While this invention has been described in terms of certain examples thereof, it is not intended that it be limited to the above description, but rather only to the extent set forth in the claims that follow.

I claim:

1. A method for provisioning security credentials in user equipment at a communication network, the method comprising:
receiving a request from user equipment (UE) for access to a communication network, wherein the request includes the IMSI (International Mobile Subscriber Identity) of the UE;
receiving proof that a device-specific key exists in the device; and
if the device-specific key matches the network device key, allowing the UE to utilize a subscription of the communication network.

2. A method for provisioning security credentials in accordance with claim 1, wherein the step of receiving a device-specific key from the UE comprises receiving a device-specific key from the UE that has been digitally signed using a device-specific Private Key.

3. A method for provisioning security credentials in accordance with claim 2, the method further comprising the step of encrypting the device-specific key.

4. A method for provisioning security credentials in accordance with claim 3, wherein the step of encrypting the device-specific key comprises encrypting the device-specific key using a manufacturer specific public key.

5. A method for provisioning security credentials in accordance with claim 3, further comprising the step of decrypting the device-specific key received from the UE.

6. A method for provisioning security credentials in accordance with claim 5, further comprising the step of checking the digital signature of the device-specific key.

7. A method for provisioning security credentials in accordance with claim 6, further comprising the step of storing the device-specific key if the digital signature is valid.

8. A method for provisioning security credentials in user equipment, the method comprising:
receiving, at a communication network, a request from user equipment (UE) for access to a communication network, wherein the request includes the IMSI of the UE; and
if there is no IMEI associated with the IMSI at the communication network, determining the IMEI associated with the IMSI at the communication network.

9. A method for provisioning security credentials in user equipment in accordance with claim 8, the method further comprising the step of comparing the IMEI associated with the IMSI at the communication network with an IMEI stored in the UE.

10. A method for provisioning security credentials in user equipment in accordance with claim 9, the method further comprising the step of provisioning security credentials if the IMEI associated with the IMSI at the communication network matches the IMEI stored in the UE.

11. A method for provisioning security credentials in user equipment in accordance with claim 9, wherein the step of comparing comprises invoking a provisioning procedure to establish the device-specific key in the UE.

12. A method for provisioning security credentials in user equipment in accordance with claim 9, the method further comprising the step of retrieving, at the communication network, a manufacturer specific public key associated with the IMEI reported by the UE.

13. A method for provisioning security credentials in user equipment in accordance with claim 12, the method further comprising the step of decrypting the device-specific key utilizing the manufacture specific private key.

14. A method for provisioning security credentials in user equipment in accordance with claim 13, the method further comprising the step of validating the digital signature of the device specific key using the public key associated with the IMEI reported by the UE.

15. A method for provisioning security credentials in user equipment in accordance with claim 14, the method further comprising the step of storing the device-specific key in a subscription record database.

16. A method for provisioning security credentials in user equipment in accordance with claim 15, wherein the step of storing the device-specific key in a subscription record database comprises storing the device-specific key in association with the bound IMEI of the UE.

17. A method for provisioning security credentials in user equipment in accordance with claim 15, wherein the step of storing the device-specific key in a subscription record database comprises storing the device-specific key by the UE.

18. A method for provisioning security credentials in user equipment in accordance with claim 8, the method further comprising the step alerting the UE that the device-specific key was properly decrypted by the communication network.

19. A method for provisioning security credentials in user equipment in accordance with claim 18, the method further comprising the step of activating the device-specific key.
